(19) United States
(12) Patent Application Publication
(10) Pub. No.: US 2010/0315483 A1
(43) Pub. Date: Dec. 16, 2010

(54) Automatic Conferencing Based on Participant Presence

(76) Inventor: Keith C. King, Austin, TX (US)

Correspondence Address: MEYERTONS, HOOD, KIVLIN, KOWERT & GOETZEL, P.C., P.O. BOX 398, AUSTIN, TX, 78767-0398, US

(21) Appl. No.: 12/724,226

(22) Filed: Mar. 15, 2010

Related U.S. Application Data
(60) Provisional application No. 61/162,041, filed on Mar. 20, 2009.

(51) Int. Cl. H04N 7/14

(52) U.S. Cl. 348/14.08; 348/E07.077

(57) ABSTRACT

Automatically initiating a videoconference in a videoconferencing system. Scheduling information may be stored for the videoconference. The scheduling information may indicate that at least one participant wishes to have a videoconference with one or more other participants at a desired time. It may be determined that the at least one participant is proximate to the videoconferencing system at approximately the desired time. An indication may be received that at least one of the one or more other participants are proximate to respective other videoconferencing systems at approximately the desired time. Accordingly, the videoconference may be automatically initiated.

### PRIORITY DATA

This application claims benefit of priority of U.S. provisional application Ser. No. 61/162,041 titled “Automatic Conferencing Based on Participant Presence” filed Mar. 20, 2009, whose inventor was Keith C. King, which is hereby incorporated by reference in its entirety as though fully and completely set forth herein.

### FIELD OF THE INVENTION

The present invention relates generally to conferencing and, more specifically, to a method for automatic conferencing based on participant presence.

### DESCRIPTION OF THE RELATED ART

Videoconferencing may be used to allow two or more participants at remote locations to communicate using both video and audio. Each participant location may include a videoconferencing system for video/audio communication with other participants. Each videoconferencing system may include a camera and microphone to collect video and audio from a first or local participant to send to another (remote) participant. Each videoconferencing system may also include a display and speaker to reproduce video and audio received from one or more remote participants. Each videoconferencing system may also be coupled to (or comprise) a general purpose computer system to allow additional functionality into the videoconference. For example, additional functionality may include data conferencing (including displaying and/or modifying a document for both participants during the conference).

Similarly, audioconferencing (e.g., teleconferencing) may allow two or more participants at remote locations to communicate using audio. For example, a speakerphone may be placed in a conference room at one location, thereby allowing any users in the conference room to participate in the audioconference with another set of participant(s) (e.g., in one or more other conference rooms with a speakerphone).

Current conferencing systems allow users to initiate conferences with each other using proprietary systems, but fail to provide adequate flexibility and responsiveness for end users. Correspondingly, improvements in initiating conferencing systems are desired.

### SUMMARY OF THE INVENTION

Various embodiments are presented of a method for automatically initiating a conference based on participant presence. Note that the method may be implemented as a computer program (e.g., program instructions stored on a computer accessible memory medium that are executable by a processor), a conferencing system (e.g., a videoconferencing system or an audioconferencing system), a computer system, etc.

Scheduling information for a conference (e.g., a videoconference) may be stored. The scheduling information may indicate that at least one user wishes to have a conference with one or more (or a plurality of) other users at a desired time. In other words, the scheduling information may indicate that a plurality of users (participants) desire a conference at a specified time. In some embodiments, the scheduling information may be stored in response to receiving input from one of the participants (or an administrator) specifying the scheduling information.

The method may determine that at least one participant is proximate to the conferencing system at approximately the desired time. In various embodiments, the method may determine that a mobile communication device of the at least one participant is proximate to the conferencing system. Alternatively, or additionally, the method may perform user recognition, e.g., audio recognition, facial recognition, etc., to determine that a participant is present. In other embodiments, the method may simply determine that a person is proximate to the conferencing system (e.g., present in the room), with out attempting to determine the identity of the person.

The method may also receive an indication (e.g., via a network from another conferencing system) which indicates that at least one of the one or more other participants are proximate to respective other conferencing systems at approximately the desired time. In some embodiments, there may be a plurality of other participants and the indication may indicate that a subset (e.g., one) of the plurality of other participants are proximate to his respective conferencing system.

The conference may be automatically initiated based on at least two of the participants being proximate to their respective conferencing systems at approximately the desired time. The automatic initiation may be performed without any user input specifying initiation of the videoconference. In some embodiments, the conference may be automatically initiated when all of the participants are proximate to their respective conferencing systems or when only a portion of the participants are proximate (e.g., when two or more participants are proximate) to their respective conferencing systems. In some embodiments, as part of the scheduling information the user may specify a “necessary subset” of the participants that must be present before the conference is automatically initiated. In this instance, the conference is automatically initiated when the necessary subset of participants are available.

### BRIEF DESCRIPTION OF THE DRAWINGS

A better understanding of the present invention may be obtained when the following detailed description is considered in conjunction with the following drawings, in which:

FIG. 1 illustrates a videoconferencing system participant location, according to an embodiment;

FIG. 2 illustrates an exemplary mobile communication device, according to an embodiment;

FIGS. 3A and 3B illustrate an exemplary mobile communication device and speaker phone, according to an embodiment;

FIGS. 4A and 4B illustrate exemplary videoconferencing systems coupled in different configurations, according to some embodiments;

FIG. 5 is a flowchart diagram illustrating an exemplary method for utilizing a mobile device as an interface to a conferencing system, according to an embodiment; and

FIG. 6 is an exemplary graphical user interface (GUI) for specifying invited and required participants, according to an embodiment.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Note that the headings are for organizational purposes only and are not meant to be used to limit or interpret the description or claims. Furthermore, note that the word “may” is used throughout this application in a permissive sense (i.e., having the potential to, being able to), not a mandatory sense (i.e., must). The term “include”, and derivations thereof, mean “including, but not limited to”. The term “coupled” means “directly or indirectly connected”.

### DETAILED DESCRIPTION OF THE EMBODIMENTS

### Incorporation by Reference

U.S. patent application titled “Video Conferencing System Transcoder”, Ser. No. 11/252,238, which was filed Oct. 17, 2005, whose inventors are Michael L. Kenoyer and Michael V. Jenkins, is hereby incorporated by reference in its entirety as though fully and completely set forth herein.

U.S. Provisional Patent Application Ser. No. 61/147,672, titled “Conferencing System Utilizing a Mobile Communication Device as an Interface”, filed on Jan. 27, 2009, whose inventors are Keith C. King and Matthew K. Brandt, is hereby incorporated by reference in its entirety as though fully and completely set forth herein.

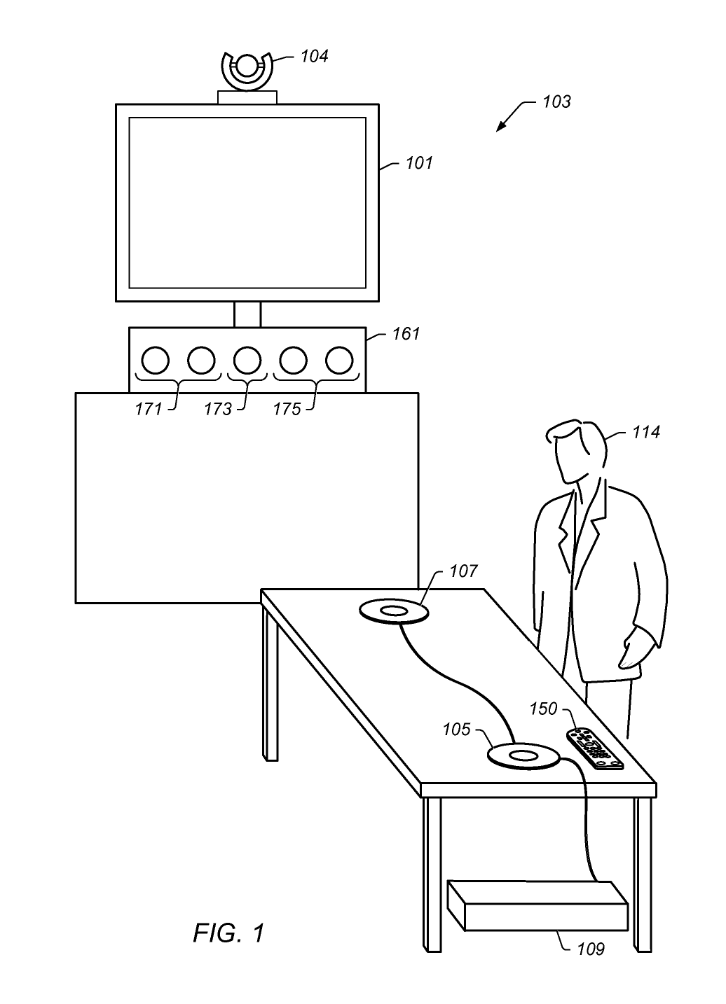

### FIG. 1—Exemplary Participant Location

FIG. 1 illustrates an exemplary embodiment of a videoconferencing participant location, also referred to as a videoconferencing endpoint or videoconferencing system (or videoconferencing unit). The videoconferencing system 103 may have a system codec 109 to manage both a speakerphone 105/107 and videoconferencing hardware, e.g., camera 104, display 101, speakers 171, 173, 175, etc. The speakerphones 105/107 and other videoconferencing system components may be coupled to the codec 109 and may receive audio and/or video signals from the system codec 109.

In some embodiments, the participant location may include camera 104 (e.g., an HD camera) for acquiring images (e.g., of participant 114) of the participant location. Other cameras are also contemplated. The participant location may also include display 101 (e.g., an HDTV display). Images acquired by the camera 104 may be displayed locally on the display 101 and/or may be encoded and transmitted to other participant locations in the videoconference.

The participant location may also include a sound system 161. The sound system 161 may include multiple speakers including left speakers 171, center speaker 173, and right speakers 175. Other numbers of speakers and other speaker configurations may also be used. The videoconferencing system 103 may also use one or more speakerphones 105/107 which may be daisy chained together.

In some embodiments, the videoconferencing system components (e.g., the camera 104, display 101, sound system 161, and speakerphones 105/107) may be coupled to a system codec 109. The system codec 109 may be placed on a desk or on a floor. Other placements are also contemplated. The system codec 109 may receive audio and/or video data from a network, such as a LAN (local area network) or the Internet. The system codec 109 may send the audio to the speakerphone 105/107 and/or sound system 161 and the video to the display 101. The received video may be HD video that is displayed on the HD display. The system codec 109 may also receive video data from the camera 104 and audio data from the speakerphones 105/107 and transmit the video and/or audio data over the network to another conferencing system. The conferencing system may be controlled by a participant or user through the user input components (e.g., buttons) on the speakerphones 105/107 and/or remote control 150. Other system interfaces may also be used.

In various embodiments, a codec may implement a real time transmission protocol. In some embodiments, a codec (which may be short for “compressor/decompressor”) may comprise any system and/or method for encoding and/or decoding (e.g., compressing and decompressing) data (e.g., audio and/or video data). For example, communication applications may use codecs for encoding video and audio for transmission across networks, including compression and packetization. Codecs may also be used to convert an analog signal to a digital signal for transmitting over various digital networks (e.g., network, PSTN, the Internet, etc.) and to convert a received digital signal to an analog signal. In various embodiments, codecs may be implemented in software, hardware, or a combination of both. Some codecs for computer video and/or audio may include MPEG, Indeo™, and Cinepak™, among others.

In some embodiments, the videoconferencing system 103 may be designed to operate with normal display or high definition (HD) display capabilities. The videoconferencing system 103 may operate with a network infrastructures that support T1 capabilities or less, e.g., 1.5 mega-bits per second or less in one embodiment, and 2 mega-bits per second in other embodiments.

Note that the videoconferencing system(s) described herein may be dedicated videoconferencing systems (i.e., whose purpose is to provide videoconferencing) or general purpose computers (e.g., IBM-compatible PC, Mac, etc.) executing videoconferencing software (e.g., a general purpose computer for using user applications, one of which performs videoconferencing). A dedicated videoconferencing system may be designed specifically for videoconferencing, and is not used as a general purpose computing platform; for example, the dedicated videoconferencing system may execute an operating system which may be typically streamlined (or “locked down”) to run one or more applications to provide videoconferencing, e.g., for a conference room of a company. In other embodiments, the videoconferencing system may be a general use computer (e.g., a typical computer system which may be used by the general public or a high end computer system used by corporations) which can execute a plurality of third party applications, one of which provides videoconferencing capabilities. Videoconferencing systems may be complex (such as the videoconferencing system shown in FIG. 1) or simple (e.g., a user computer system with a video camera, microphone and/or speakers). Thus, references to videoconferencing systems, endpoints, etc. herein may refer to general computer systems which execute videoconferencing applications or dedicated videoconferencing systems. Note further that references to the videoconferencing systems performing actions may refer to the videoconferencing application(s) executed by the videoconferencing systems performing the actions (i.e., being executed to perform the actions).

The videoconferencing system 103 may execute various videoconferencing application software that presents a graphical user interface (GUI) on the display 101. The GUI may be used to present an address book, contact list, list of previous callees (call list) and/or other information indicating other videoconferencing systems that the user may desire to call to conduct a videoconference.

Note that the videoconferencing system shown in FIG. 1 may be modified to be an audioconferencing system. The audioconferencing system, for example, may simply include speakerphones 105/107, although additional components may also be present. Various embodiments described herein describe the use of a mobile communication device as an interface to the conferencing system. Additionally, note that any reference to a “conferencing system” or “conferencing systems” may refer to videoconferencing systems or audioconferencing systems (e.g., teleconferencing systems).

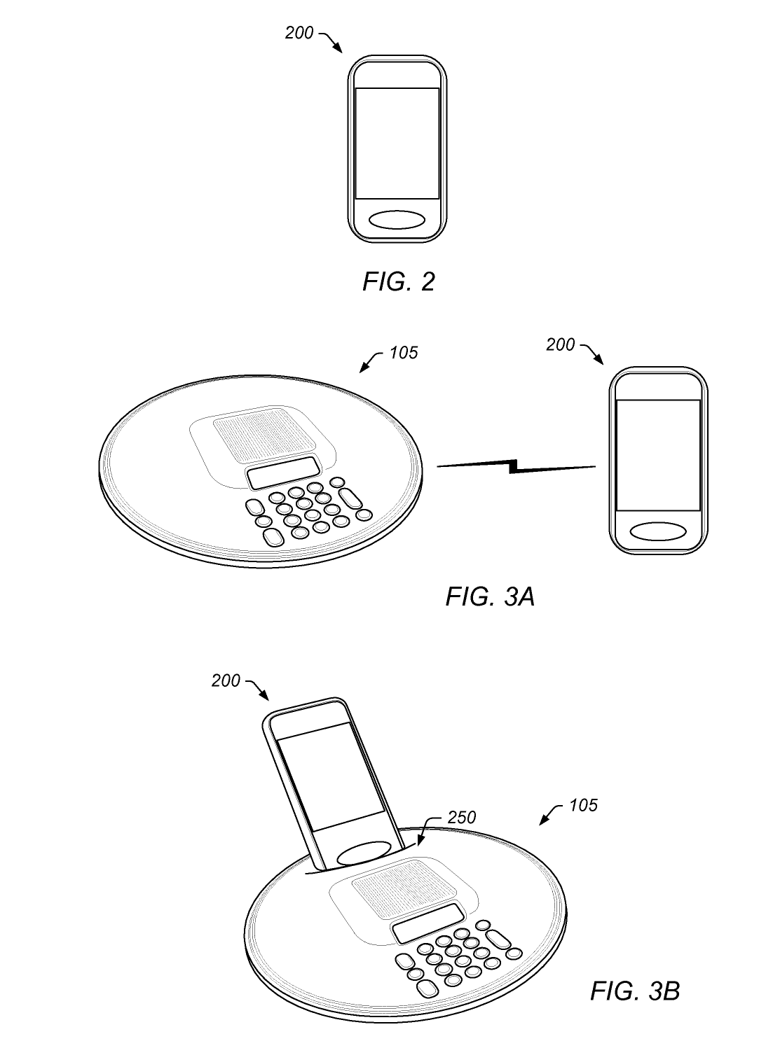

### FIGS. 2-3B—Mobile Communication Device

FIG. 2 illustrates an exemplary mobile communication device, which may be used in various embodiments described below, to identify or detect when a participant is proximate to the videoconferencing system of FIG. 1. The mobile communication device 200 may be any type of portable or mobile device that is capable of communicating in a wireless fashion. For example, the mobile communication device may be a cell phone or mobile telephone. In one embodiment, the mobile communication device may be a smart phone such as an iPhone™ provided by Apple Corporation, Instinct™ provided by Samsung Mobile, or a Blackberry™ provided by RIM, although other smart phones are envisioned. Thus the mobile communication device 200 may be a mobile device with wireless communication capabilities, e.g., telephonic communication capabilities.

In various embodiments, the mobile communication device 200 may trigger automatic initiation of an audioconference or videoconference. Additionally, the mobile communication device 200 may be usable as an interface to the audioconferencing or videoconferencing system, e.g., using an application installed on the mobile communication device 200, as described in U.S. Provisional Patent Application Ser. No. 61/147,672, titled “Conferencing System Utilizing a Mobile Communication Device as an Interface”, by Keith C. King and Matthew K. Brandt, which was incorporated by reference above.

FIGS. 3A and 3B illustrate the exemplary mobile communication device 200 communicating with the conferencing system 103. More specifically, FIG. 3A illustrates an embodiment where the mobile communication device 200 may communicate with the conferencing system 103 (e.g., via the speakerphone 105, as shown) in a wireless manner. For example, the wireless communication may be performed using any of various wireless protocols, such as 802.11x (e.g., 802.11g, 802.11n, etc.), Bluetooth, etc. In one embodiment, the videoconferencing system 103 (e.g., the speakerphone 105) and the mobile communication device 200 may be coupled to the same wireless network and may communicate on that network. In another embodiment, the speakerphone 105 (or another component of the videoconferencing system 103) may provide wireless access point functionality for the mobile communication device 200, e.g., to provide local network connectivity and/or wide area network connective (e.g., the Internet). Alternatively, the wireless communication device 200 may physically couple to the videoconferencing system 103 (e.g., via the speakerphone 105, e.g., using a wired connection, or by docking to the speakerphone 105 via dock 250, as shown in FIG. 3B).

In some embodiments, the mobile communication device 200 may simply couple to a dock coupled to the videoconferencing system 103 (e.g., via USB). For example, the mobile communication device 200 may be able to communicate with the videoconferencing system 103 via wired means (e.g., of the dock) and may be configured to receive power for charging. Thus, the mobile communication device 200 may be configured to communicate with the videoconferencing system 103 via wired or wireless means, and may be usable for automatically initiating a videoconference, as described below.

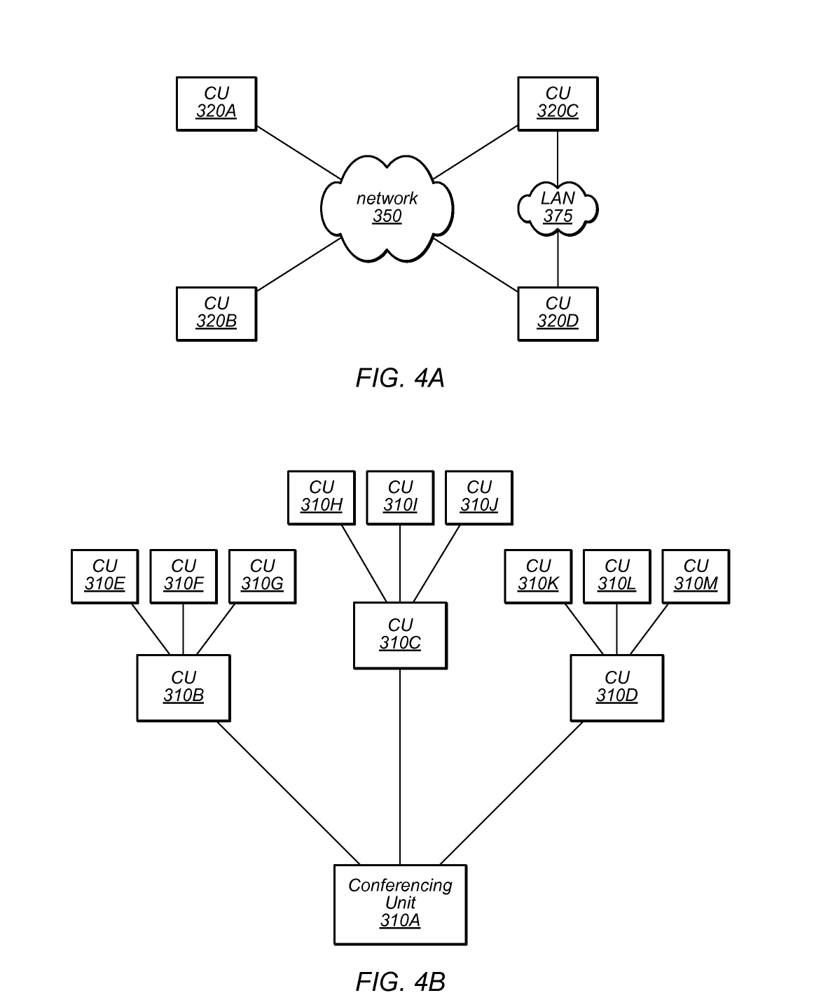

### FIGS. 4A and 4B—Coupled Conferencing Systems

FIGS. 4A and 4B illustrate different configurations of conferencing systems. The conferencing systems may be operable to automatically initiate a conference based on detection of participant presence, e.g., based on detection of a mobile communication device 200, as described in more detail below. As shown in FIG. 4A, conferencing systems (CUs) 320A-D (e.g., videoconferencing systems 103 described above) may be connected via network 350 (e.g., a wide area network such as the Internet) and CU 320C and 320D may be coupled over a local area network (LAN) 375. The networks may be any type of network (e.g., wired or wireless) as desired.

FIG. 4B illustrates a relationship view of conferencing systems 310A-310M. As shown, conferencing system 310A may be aware of CU 310B-310D, each of which may be aware of further CU's (310E-310G, 310H-310J, and 310K-310M respectively). CU 310A may be operable to automatically initiate a conference based on participant presence according to the methods described herein, among others. In a similar manner, each of the other CUs shown in FIG. 3B, such as CU 310H, may be able to also detect and initiate conferences based on participant presence, as described in more detail below. Similar remarks apply to CUs 320A-D in FIG. 3A.

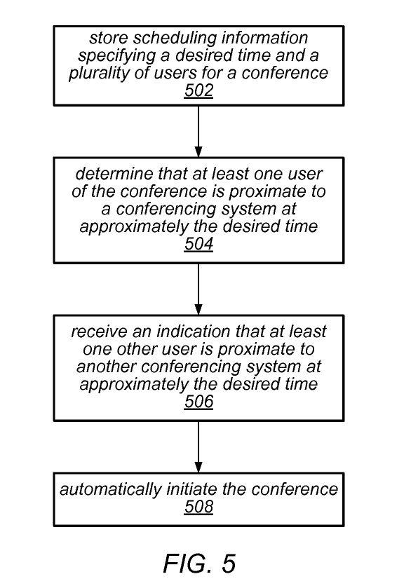

### FIG. 5—Automatic Initiation of a Conference Based on Participant Presence

FIG. 5 illustrates a method for automatically initiating a conference based on participant presence. The method shown in FIG. 5 may be used in conjunction with any of the computer systems or devices shown in the above Figures, among other devices. In various embodiments, some of the method elements shown may be performed concurrently, performed in a different order than shown, or omitted. Additional method elements may also be performed as desired. As shown, this method may operate as follows.

In 502, scheduling information for a conference may be stored. The scheduling information may specify a desired time (and date, if necessary) for the conference (e.g., a videoconference or audioconference). The scheduling information may also specify that a conference is desired among a plurality of participants, i.e., at least one user wishes to have a conference with one or more other users at a desired time. Thus, the scheduling information may specify a conference at the desired time for a plurality of users. In one embodiment, the desired time may be specified and/or agreed upon by all of the plurality of users. However, in alternate embodiments, a single user may provide the scheduling information (e.g., requesting the other users) and those other users may choose to accept the invitation and/or join the conference at the desired time. However, in some embodiments, the user scheduling the conference may not be a participant in the conference.

The scheduling information may be stored in response to user input (e.g., from the at least one user, or any of the users being scheduled) specifying the scheduling information, possibly over a network. Thus, in one embodiment, a user may provide the scheduling information, e.g., to a particular conferencing system over a network, possibly using a scheduling client, such as a web browser that interfaces to an application on a server, or alternatively an application such as Microsoft Outlook™, Lotus Notes™, and/or other scheduling application. In further embodiments, a user may request that the other users join a videoconference immediately, and the current time may be set as the desired time. Thus, the scheduling information may be for any time from the current time to a future date and time.

The scheduling information may specify conferencing systems for the plurality of participants (the scheduled users). For example, each participant may have or use a respective conferencing system, and the scheduling information may specify each of those conferencing systems. However, it may be possible that two of the participants may share a conferencing system for the conference at the desired time. Alternatively, or additionally, the scheduling information may simply specify the participants, and whichever conferencing system that is closest to each participant at the desired time may be used. Note that at least two conferencing systems may be used for the conference at the desired time. In one embodiment, the user providing the scheduling information provides the names of the desired participants, and the software determines the appropriate numbers/IP addresses (conference systems) to dial to place the various calls to establish the conference, e.g., using a directory.

In one embodiment, the scheduling information may specify “required” participants who must be present before automatic initiation of the videoconference is performed. For example, for a meeting including five participants, the scheduling information may indicate that three of the participants are “required” for the conference to be automatically initiated, as described below. Thus, by specifying “required” participants, it can be ensured that these participants do not miss any part of the conference (since it may not be started without them).

In one embodiment, where one or more participants are indicated to be “required” participants, a participant may still be able to override this setting and select an option (manually) to initiate the videoconference. For example, if one participant is listed as “required” but is not present, one or more participants who are present and are waiting for the conference to begin can manually override this setting and start the conference.

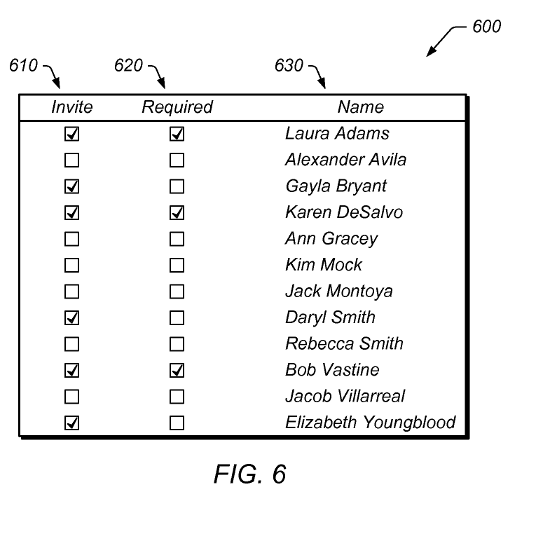

FIG. 6 illustrates an exemplary graphical user interface (GUI) 600 for specifying invited and required participants when specifying scheduling information. As shown, the GUI 600 may include a list of names 630 (e.g., of known contacts in a specified order, e.g., alphabetically) and a plurality of checkboxes. The plurality of checkboxes may corresponds to invited participants (610) and required participants (620). As shown, the user has specified that Laura Adams is a required participant, Gayla Bryant is invited but not required, Karen DeSalvo is required, Daryl Smith is invited but not required, Bob Vastine is a required participant, and Elizabeth Youngblood is invited but not required. Note that in some embodiments, when a participant is indicated as “required” the “invite” indication may be automatically specified. Thus, a user may use a GUI (e.g., similar to the GUI 600) for specifying invited and/or required participants for a conference.

In 504, the method may determine (e.g., by a conferencing system) that at least one participant of the conference is proximate to the conferencing system at approximately the desired time. As used herein, a participant being “proximate” to the conferencing system refers to the participant being sufficiently close to the conferencing system to be able to participate in the conference. As an alternative, a participant may be “proximate” to the conferencing system when the participant is sufficiently close to the conferencing system such that it can be presumed that the participant is standing by waiting for the conference to start. For example, “proximate” may refer to the participant being in the same room as the conferencing system, or in various embodiments being 5, 10, 15, 25, or up to 60 feet away from the conferencing system, as desired. In some embodiments, is the participant is in the same room as the conferencing system, the participant is considered “proximate” to the conferencing system no matter how far away the participant is from the system.

As used herein, “approximately the desired time” may refer to any time near the desired time which allows a participant who is joining the conference to be early or late for the conference. For example, “approximately the desired time” may refer to deviations within 5 minutes of the desired time (e.g., up to five minutes before or after the desired time), deviations within 10 minutes, deviations within 15 minutes, or possibly deviations within 30 minutes.

Determining that the participant is proximate to the conferencing system at approximately the desired time may be performed via a variety of methods. For example, in one embodiment, the participant may have a mobile communication device, such as a cell phone. The mobile communication device and the conferencing system may communicate, e.g., in a wireless fashion. For example, the mobile communication device may communicate using any of a variety of communication protocols, such as short distance protocols (e.g., Bluetooth), local area network protocols (e.g., 802.11x protocols), or other communication protocols. The mobile communication device may provide identification information of the mobile communication device or of the participant (who uses the mobile communication device) to the conferencing system. In various embodiments, the mobile communication device may have been previously associated with the participant by the conferencing system (e.g., the participant may register the cell phone as his cell phone with the conferencing system, or possibly with software that is able to communicate the association to the conferencing system, e.g., via a network). Thus, in some embodiments, the mobile communication device may provide identification information, and the conferencing system may determine that the participant is proximate to the conferencing system in response to the identification information. As discussed below, the mobile communication device may also provide location information, e.g., GPS information.

In some embodiments, the communication protocol used may indicate that the participant is proximate to the conferencing system. For example, where short range protocols are used, such as Bluetooth (which may typically be used for 10 meters or less), the fact that the mobile communication device and the conferencing system can communicate may be enough to determine that the participant is proximate to the conferencing system. Alternatively, the distance to the conferencing system may be determined based on triangulation of available wireless network access points (e.g., by determining the location of the mobile communication device based on which wireless networks are “visible” to the mobile communication device, and then performing location based calculations).

In some embodiments, signal strength of the communication may be used to determine the distance of the mobile communication device from the conferencing system. For example, when using a wireless area network protocol, such as 802.11x, simple detection or communication of the mobile communication device may not indicate that the mobile communication device is proximate to the conferencing system. More specifically, since wireless area networks can currently have a range up to 70 meters, simple detection of the mobile communication device on the wireless network may not indicate that the participant is close enough to the conferencing system to participate the conference. In such instances, the received signal strength of the mobile communication device may indicate how close it is to the conferencing device. For example, if the wireless access point is close to the conferencing system, if there is a very strong signal, the mobile communication device may be proximate to the conferencing system, whereas a weak signal may indicate that the mobile communication device is not proximate to the conferencing system. In some embodiments, the determination that the mobile communication device is proximate to the conferencing system may be determined based on thresholds (e.g., predetermined thresholds) for signal strength. For example, the method may use techniques described in U.S. Pat. No. 6,414,635, which is hereby incorporated by reference.

Additionally, the rate of change of signal strength may allow the conferencing system (or other system) to determine how close the participant is. For example, if the signal strength is getting stronger over time, it may be determined that the participant is approaching the wireless access point, and that information may be usable to determine whether the participant is proximate to the conferencing system (e.g., where the wireless access point is close the conferencing system, or alternatively, where the conferencing system location is known with respect to the wireless access point). As another example, if the signal strength is getting stronger and then weaker over time, it may be determined that the participant has walked past the wireless access point, or otherwise reached a signal strength maxima along his path. Thus, signal strength may be used to determine relative proximity to the wireless access point, and that information may be used to determine whether the participant is proximate (or likely to be proximate, e.g., at the current time or in the future) to the conferencing system.

In some embodiments, the mobile communication device may determine location information and provide the location information to the conferencing device. The conferencing device may use that information to determine if the mobile conferencing system is proximate to the conferencing device. For example, the mobile communication device may include global positioning system (GPS) circuitry that determines location information and may provide that information to the conferencing device, e.g., as a wireless signal. As one example, where the participant walks into the conference room with an IPHONE™ having GPS circuitry, the phone may determine the participant's location and provide this location information to the conferencing system. Alternatively, the phone may communicate with the conferencing system and use GPS (or other methods) to determine that it is proximate to the conference system, and may simply automatically provide a signal to the conferencing system indicating that the participant is present for the call.

Alternatively, or additionally, the mobile communication device may be configured to determine location information based on triangulation of cell phone towers (e.g., using the signals received from a plurality of cell phone towers), triangulation of available wireless access points (e.g., where the locations of those wireless access points are known), IP address location information, and/or any other methods. The conferencing system (or other device(s), possibly including the mobile communication device itself) may then compare the location information of the mobile communication device with the known location of the conferencing system to determine if the mobile communication device (and therefore the participant) is proximate to the conferencing system.

In addition, or alternatively to, using the mobile communication device to determine that the participant is proximate to the conferencing system, the conferencing system may be configured to utilize user recognition (e.g., facial recognition) to detect the participant. For example, where the conferencing system is a videoconferencing system, the camera used for the videoconference (or possibly another camera) may capture an image of the participant and processing may be performed (e.g., by the conferencing system) to determine if the image corresponds to a participant scheduled for the conference in 502 above. For example, the image may include an image of the participant's face, and the participant may be confirmed as being proximate to the conferencing system where facial recognition processing confirms that the participant is present in the room. Similarly, the conferencing system may be able to perform audio recognition of the participant's voice to confirm that the participant is proximate to the conferencing system. For example, the participant could say “John is present” or simply talk to someone else in the room. Correspondingly, the conferencing system may identify the participant as being present, e.g., by comparing the recorded voice with a known sample of the participant's voice. Thus, the conferencing system may detect when the participant speaks and may determine if the voice of the speaker is one of the participants scheduled for the conference.

In some embodiments, the conferencing system may be coupled to a security system of the conferencing room or building. The security system may be configured to provide information indicating whether the participant is proximate to the conferencing system (e.g., in the same room as the conferencing system). For example, the conferencing room may include security features, such as card access, finger printing, etc. in order to allow a participant into the conferencing room. Thus, where the participant scans his card, provides his fingerprint, etc. in order to enter the room, the security system may provide an indication to the conferencing system that the participant has entered the room. Alternatively, the security system may track users (e.g., using heat sensors or video cameras) and their location information may be provided to the conferencing system as they approach or enter the conferencing location. Correspondingly, it may be determined (e.g., by the conferencing system) that the participant is proximate to the conferencing system.

Additionally, or alternatively, the conferencing system may be able to generically determine that a participant is proximate to the conferencing system, e.g., in the same room as the conferencing system. For example, the conferencing system may include or be coupled to a heat sensor which may indicate that a participant has entered the room. The conferencing system may attempt to verify the identity of the participant, e.g., using any of the methods described above. However, where no verification is possible, the conferencing system may assume that the participant that is proximate to the conferencing system is one of the participants scheduled for the conference based on a comparison of the scheduled time and the time that the participant is detected. For example, where the current time and the scheduled time is approximately the same, the conferencing system may assume that the participant is there for the conference.

In various ones of the embodiments above, the conferencing system may determine (e.g., based on received information) that a participant is proximate to the conferencing system. The conferencing system may then confirm that that participant is scheduled for a conference at approximately that time.

In order to determine if the participant is proximate to the conference at approximately the scheduled time, the conferencing system may compare the time of the detection of the participant with the scheduled time of the conference. The conferencing system may then determine if the difference is within a threshold value to determine if the time of detection is at “approximately” at the scheduled time.

In some embodiments, after determining that the participant is proximate to the conferencing system at approximately the desired or scheduled time, the conferencing system may send an indication that the participant is proximate to the conferencing system and may be ready to start the conference. The indication may be sent to the other conferencing systems that are scheduled for the conference. Alternatively (e.g., where the specific conferencing systems are determined dynamically, based on proximity to the participating participants), the indication may be sent to a server or other computer system which may be used to coordinate the conference (e.g., to let each conferencing system know which other conferencing systems (e.g., conferencing system IDs), addresses (e.g., IP addresses), telephone numbers, etc., should be used in the conference.

In 506, an indication may be received that at least one other participant is proximate to another conferencing system at approximately the desired time. The other conferencing system(s) may perform the determination in 504 for their respective participants, and then send an indication, either to the conferencing system or a server in communication with the conferencing system.

In 508, the conference may be automatically initiated. As used herein, “automatic” initiation of the conference refers to the initiation of the conference without participant input specifying initiation of the conference. In other words, in one embodiment, other than previously scheduling the conference in 502 and possibly “showing up” to the conference room at or close to the appointed time, the participant may not need to do anything for the conference to start. For example, the term “automatically” or “automatically initiating” refers to the system performing the required steps to place the various calls to start the videoconference, without the participant having to manually dial any participants, and also without the participant having to even manually press an autodial button. Since “automatic” initiation of the conference means that no user input is required to start the conference, the conference system itself either 1) determines that one or more participants are present; or 2) receives some type of input indicating user presence, such as from mobile communication devices of participants, or voice recognition of participant's voices. In this latter example, the input received merely indicates presence of the participant, and this input by itself is not for initiating the conference. Thus, in other words, “automatically” initiating the conference may involve some input, possibly from the participant, which merely indicates user presence. However, “automatically” initiating the conference does not involve any manual user input which is typically performed by a user to actually places calls or start the videoconference.

In some embodiments, the conference may be automatically initiated when at least two participants (using different conferencing systems) are in proximity to their respective conferencing systems at approximately the desired time. For example, the conference may include three participants, but the conference may be automatically initiated when two of the participants are present rather than all of the participants. Alternatively, the conference may only begin when a threshold percentage of participants are present, e.g., 33%, 50%, 67%, 75%, 90%, or 100%.

As discussed above, the conference may be automatically initiated only when all participants indicated as “required” (e.g., as specified by the scheduling information) are determined to be present. In various embodiments, the full number of “required” participants may override any threshold number for beginning the conference. For example, where the normal threshold for automatic initiation of a conference is 50% and there are four participants scheduled for a conference (where three of them are indicated as “required”), the conference may not be automatically initiated until all three of the required participants are present.

In various embodiments, the conferencing system may indicate what is required before the conference will be automatically initiated. For example, the conferencing system may indicate that the required percentage or number of participants has not been reached (e.g., possibly listing the current present participants and/or the current missing participants). As another example, the conferencing system may indicate that certain required participants are not present (e.g., listing the missing required participants). In such embodiments, the participants that are present may have the ability to override the conferencing system and initiate the conference. For example, the conferencing system may have a button (e.g., physical or in a GUI) which the participant may select to initiate the conference even though some requirement for automatic initiation has not been reached.

Furthermore, the automatic initiation of the conference may not happen immediately. For example, the conference may not be initiated immediately so that one or more of the participants may prepare for the conference (e.g., to set up a presentation, among other possible tasks). In one embodiment, the participant may be able to request additional time, e.g., via the conferencing system, may have a preference associated with his user profile that indicates a certain amount of time for set up (e.g., 5 minutes, 10 minutes, etc.), or other embodiments for delaying the automatic initiation of the conference. However, in alternate embodiments, the conference may automatically initiate as soon as at least two participants (or all participants) are present.

Once initiated, the conference may be controlled by one or more mobile communication devices, e.g., as described in “Conferencing System Utilizing a Mobile Communication Device as an Interface” which was incorporated by reference in its entirety above.

### ADVANTAGES OF THE METHOD

By automatically initiating the conference based on participant presence, the participants do not have to perform the normally required tasks of manually attempting to initiate the conference, e.g., by selecting the participants and then providing input to initiate the conference. Additionally, the participants will not have to check to see if the other participants have arrived (e.g., by attempting to initiate the conference and failing if the other participants are not yet available), thus reducing the headaches in initiating the conference.

Additionally, by automatically initiating the conference based on participant presence, the conference takes on a much more “in person” type of interaction. For example, in a face to face meeting, whenever two participants of the meeting are in the same room, each participant is able to see each other, even if the conference has not “officially” started. The same type of feeling and interaction can occur with the conference by utilizing the automatic initiation described above.

Embodiments of a subset or all (and portions or all) of the above may be implemented by program instructions stored in a memory medium or carrier medium and executed by a processor. A memory medium may include any of various types of memory devices or storage devices. The term “memory medium” is intended to include an installation medium, e.g., a Compact Disc Read Only Memory (CD-ROM), floppy disks, or tape device; a computer system memory or random access memory such as Dynamic Random Access Memory (DRAM), Double Data Rate Random Access Memory (DDR RAM), Static Random Access Memory (SRAM), Extended Data Out Random Access Memory (EDO RAM), Rambus Random Access Memory (RAM), etc.; or a non-volatile memory such as a magnetic media, e.g., a hard drive, or optical storage. The memory medium may comprise other types of memory as well, or combinations thereof. In addition, the memory medium may be located in a first computer in which the programs are executed, or may be located in a second different computer that connects to the first computer over a network, such as the Internet. In the latter instance, the second computer may provide program instructions to the first computer for execution. The term “memory medium” may include two or more memory mediums that may reside in different locations, e.g., in different computers that are connected over a network.

In some embodiments, a computer system at a respective participant location may include a memory medium(s) on which one or more computer programs or software components according to one embodiment of the present invention may be stored. For example, the memory medium may store one or more programs that are executable to perform the methods described herein. The memory medium may also store operating system software, as well as other software for operation of the computer system.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A computer accessible memory medium comprising program instructions for initiating a videoconference in a videoconferencing system, wherein the program instructions are executable to:
store scheduling information for the videoconference, wherein the scheduling information indicates that at least one participant wishes to have a videoconference with one or more other participants at a desired time;
determine that the at least one participant is proximate to the videoconferencing system at approximately the desired time;
receive an indication that at least one of the one or more other participants are proximate to respective other videoconferencing systems at approximately the desired time; and
automatically initiate the videoconference based on said determining and said receiving, wherein said automatically initiating is performed without any user input specifying initiation of the videoconference.

2. The memory medium of claim 1, wherein said determining that the at least one participant is proximate to the videoconferencing system comprises determining that a mobile communication device of the at least one participant is proximate to the videoconferencing system.

3. The memory medium of claim 1, wherein said determining that the at least one participant is proximate to the videoconferencing system comprises performing facial recognition on the at least one participant.

4. The memory medium of claim 1, wherein said determining that the at least one participant is proximate to the videoconferencing system comprises determining that a participant is proximate to the videoconferencing system at approximately the desired time.

5. The memory medium of claim 1, wherein said storing the scheduling information is performed in response to receiving input from the at least one participant specifying the scheduling information, prior to said determining.

6. The memory medium of claim 1, wherein said receiving the indication is performed via a network and from the respective other videoconferencing systems.

7. The memory medium of claim 1, wherein the one or more other participants comprise a plurality of participants and wherein the at least one of the one or more other participants comprises a single participant of the plurality of participants.

8. A method for initiating a conference in a videoconferencing system, comprising:
storing scheduling information for the conference, wherein the scheduling information indicates that at least one participant wishes to have a conference with one or more other participants at a desired time;
determining that the at least one participant is proximate to the conferencing system at approximately the desired time;
receiving an indication that at least one of the one or more other participants are proximate to respective other conferencing systems at approximately the desired time; and
automatically initiating the conference based on said determining and said receiving, wherein said automatically initiating is performed without any user input specifying initiation of the conference.

9. The method of claim 8, wherein said determining that the at least one participant is proximate to the conferencing system comprises determining that a mobile communication device of the at least one participant is proximate to the conferencing system.

10. The method of claim 8, wherein said determining that the at least one participant is proximate to the conferencing system comprises performing facial recognition on the at least one participant.

11. The method of claim 8, wherein said determining that the at least one participant is proximate to the conferencing system comprises determining that a participant is proximate to the conferencing system at approximately the desired time.

12. The method of claim 8, wherein said storing the scheduling information is performed in response to receiving input from the at least one participant specifying the scheduling information, prior to said determining.

13. The method of claim 8, wherein said receiving the indication is performed via a network and from the respective other conferencing systems.

14. The method of claim 8, wherein the one or more other participants comprise a plurality of participants and wherein the at least one of the one or more other participants comprises a single participant of the plurality of participants.

15. A videoconferencing system, comprising:
a processor;
a network port coupled to the processor; and
a memory medium, comprising program instructions, wherein the program instructions are executable by the processor to:
store scheduling information for a videoconference, wherein the scheduling information indicates that at least one participant wishes to have a videoconference with one or more other participants at a desired time;
determine that the at least one participant is proximate to the videoconferencing system at approximately the desired time;
receive an indication that at least one of the one or more other participants are proximate to respective other videoconferencing systems at approximately the desired time via the network port; and
automatically initiate the videoconference based on said determining and said receiving, wherein said automatically initiating is performed without any user input specifying initiation of the videoconference.

16. The videoconferencing system of claim 15, wherein said determining that the at least one participant is proximate to the videoconferencing system comprises determining that a mobile communication device of the at least one participant is proximate to the videoconferencing system.

17. The videoconferencing system of claim 15, wherein said determining that the at least one participant is proximate to the videoconferencing system comprises performing facial recognition on the at least one participant.

18. A computer accessible memory medium comprising program instructions for initiating a conference in a conferencing system, wherein the program instructions are executable to:
store scheduling information for the conference, wherein the scheduling information indicates that a plurality of participants at respective locations desire to have a conference at a desired time;
determine that at least two participants of the plurality of participants are proximate to their respective conferencing systems at approximately the desired time;
automatically initiate the conference based on said determining.

19. The memory medium of claim 18, wherein said determining that the at least two participants are proximate to the conferencing system comprises determining that a mobile communication device of one of the two participants is proximate to the respective conferencing system.

20. The memory medium of claim 18, wherein said determining that the at least one participant is proximate to the conferencing system comprises performing facial recognition on at least one of the two participants.

21. A method for initiating a videoconference in a videoconferencing system, wherein the program instructions are executable to:
store scheduling information for the videoconference, wherein the scheduling information indicates that a plurality of participants at respective locations desire to have a videoconference at a desired time;
determine that at least two participants of the plurality of participants are proximate to their respective videoconferencing systems at approximately the desired time;
automatically initiate the videoconference based on said determining.

22. The method of claim 21, wherein said determining that the at least two participants are proximate to the videoconferencing system comprises determining that a mobile communication device of one of the two participants is proximate to the respective videoconferencing system.

23. The method of claim 21, wherein said determining that the at least one participant is proximate to the videoconferencing system comprises performing facial recognition on at least one of the two participants.
